(19) United States
(12) Patent Application Publication
(10) Pub. No.: US 2016/0004696 A1
(43) Pub. Date: Jan. 7, 2016

(54) CALL AND RESPONSE PROCESSING ENGINE AND CLEARINGHOUSE ARCHITECTURE, SYSTEM AND METHOD

(71) Applicants: Hristo Trenkov, Rockville, MD (US); George Ianakiev, Chevy Chase, MD (US)

(72) Inventors: Hristo Trenkov, Rockville, MD (US); George Ianakiev, Chevy Chase, MD (US)

(21) Appl. No.: 14/324,224

(22) Filed: Jul. 6, 2014

(51) Int. Cl. G06F 17/30; G06F 17/28

(52) U.S. Cl. CPC G06F 17/3043; G06F 17/30401; G06F 17/28

(57) ABSTRACT

A computer-based method to identify and solve problems that exist in a real-world system by cross-functional, cross-industry logic methods and technology-enabled infrastructure to facilitate inventive business problem solving through integrated system and method to (1) formulate search questions and send a call request, (2) receive the call and execute the search question, (3) receive the search question results and packages them into a response message, (4) sends response message corresponding to the call request.

The underlying data can be structured or unstructured in nature. For unstructured data, more particularly, the present invention allows users to state questions or problems in plain language (English or other), audio, images, video, sensor data, or other information format. The present invention then analyzes the information and performs semantic information extraction to translate the human-stated questions (or problem queries) into Resource Description Framework (RDF) data model ontological subject-predicate-object expressions (triples, in RDF terminology). The question (or problem) statement defined in RDF format, is based on the Ontology-based Search Engine compatible parameters, which allows specific answers (or solutions) to be identified. Extracted questions/problems and answers/solutions are integrated back into the data model.

### CROSS REFERENCE TO RELATED PROVISIONAL APPLICATION

This application claims the benefit of U.S. Provisional Patent Application No. 61/843,431 filed on Jul. 7, 2013, the disclosure of which is hereby incorporated herein by reference in its entirety.

### COPYRIGHT NOTICE

Portions of the disclosure of this document contain materials that are subject to copyright protection. The copyright owner has no objection to the facsimile reproduction of the patent document or patent disclosure as it appears in the U.S. Patent and Trademark Office patent files or records solely for use in connection with consideration of the prosecution of this patent application, but otherwise reserves all copyright rights whatsoever.

### FIELD OF THE INVENTION

The present invention generally relates to cross-functional, cross-industry logic methods and technology-enabled infrastructure to facilitate search, integration and retrieval of knowledge and responses through integrated systems and methods to (1) formulate search questions and send a call request, (2) receive the call and execute the search question, (3) receive the search question results and packages them into a response message, (4) sends response message corresponding to the call request.

In one embodiment, the present invention allows users to state questions or problems in plain language (English or other), audio, images, video, sensor data, or other information format. The present invention then analyzes the information and performs semantic information extraction to translate the human-stated questions (or problem queries) into Resource Description Framework (RDF) data model ontological subject-predicate-object expressions (triples, in RDF terminology). The question (or problem) statement defined in RDF format, is based on the Ontology-based Search Engine compatible parameters, which allows specific answers (or solutions) to be identified. Extracted questions/problems and answers/solutions are integrated back into the data model. The Ontology-based Search Engine is enabled by knowledge metadata, which in one embodiment is based on TRIZ-informed contradiction matrix and principles tailored to the specific domain of business or science.

### BACKGROUND OF THE INVENTION

Today's economic-political landscape makes it necessary for organizations, research institutions, and governments to be able to react and adapt quickly to external and internal challenges and stresses. Markets and governments respond almost instantaneously to changes in the economic-political landscape, so it is of utmost importance for an organization to be continuously apprised of these changes and to respond accordingly. Additionally, it is important for organizations to know how to respond. Data output is increasing exponentially, and, by extension, the amount of information available to individuals and organizations is increasing exponentially. Organizations can use this data as a springboard for developing action plans, focus research and development efforts, and gain advantage in their field of operations.

In 2007, 85% of all data is in an unstructured format[1] for businesses and organizations to utilize easily. This number is growing as the capacity of conventional data collection surpasses the capacity for organizing that data and today the available data is measured in zettabytes (1 zettabyte=1 trillion gigabytes). To make this wealth of data more usable, new technologies and methods are required to describe the data ontologically and in the context it is harvested and applied. New software and hardware implementations allow for the integration and subsequent retrieval of data. While acquiring data across different media, systems will need to be able to integrate data, structured and stored in discrepant and isolated systems. Big Data has become so voluminous that it is no longer feasible to manipulate and move it all around.

Many innovations and advancements are already available to Organizations and individuals today. However, today's challenges are bigger and more complex than the ability for one system (such as OLFDF or BTPES) alone to provide a technical, logical, scalable, and sustainable solution. The main challenges of being able to use, search and mine data remain to be (1) how new data is integrated and (2) how data is retrieved. There is significant in-progress research, enhancements and prototypes to advance the traditional search engines (e.g. Google, Bing, Yahoo, etc) from being keyword-based to becoming ontology-based search engines. This has proven to be difficult and challenging to achieve high accuracy of the results. 1. http://www.forbes.com/2007/04/04/teradata-solution-software-biz-logistics-cx rm 0405data.html

The underlying algorithms are different than what a conventional ontology-based search engine would use, as it utilizes (in one embodiment) TRIZ-informed matrix and logic to enable the integration and retrieval of knowledge into the search engine. In this embodiment, the TRIZ-informed matrix and logic follows the same principles as the traditional TRIZ, but for the purposes of ad-hoc, near real-time (seconds or less) answers to questions in the business and science domains. Note that in a more general embodiment, (instead of TRIZ-informed matrix and logic), semantic technology methods are used to perform the same function(s). The domain data are organized ontologically in ways to facilitate management of the data repository. This allows relevant data to be identified and retrieved easily, in the right context, allowing data to be manipulated and analyzed. Metadata gathered on these data sources are stored in the underlying ontology and are manipulated to derive useful knowledge from structured or unstructured data. This streamlined process enables Organizations to reduce operation time and cost, which are major sources of expenditures [1], which is to say that it has not been cataloged and made readily available[2]. 2. http://www.forbes.com/2010/10/08/legal-security-requirements-technology-data-maintenance.html

### SUMMARY OF THE INVENTION

The present invention is a computer-based method and apparatus for interpreting questions (or problems) that exist in a business or science system in the form of Calls, and identifying relevant answers (or solutions) in the form of Responses. Further, the present invention operates as a asynchronous messaging system allowing high volumes of “calls” and “responses” to be processed without visible performance degradation.

Typically, the type of business or science systems to which the present invention is applied are those such as engineering environments, technical domain-specific environments, business environments, social environments, behavioral environments, economic environments, political environments, and individual components. Examples of systems include a a purchasing data, manufacturing plant, a Next Generation Genome sequencing laboratory, a customer segmentation group, a geographical region, a conflict or area of political interest, a technology product. Note that the above list of system problems is representative and the present invention can be applied to any business or science “systems” in virtually any field of human endeavor and in conjunction with any system where there are questions to be identified and answered.

A typical user of the present invention is an individual contributor of the system, individual who is interested in gaining insight of the behavior of the system under certain conditions, or someone who is interested in influencing the parameters definite the system (hence the system itself).

The present invention can be deployed in a structured data construct where the “calls” and the “responses” are targeting relational database repositories. In another embodiment, the present invention can be deployed in a non-structured data construct where no precise answers exist. In such case, commonly, business questions and problems appear in patterns and can be found in other non-related domains. Recognizing this provides a platform for answering questions of interest quickly and efficiently. Instead of having to develop a unique answer, an answer can be adapted from an extant answer to a question in another field of business, science or human knowledge. The users react to similar questions follows predictable patterns. This presents an opportunity to systematize the answers when a question is identified. In one embodiment, business or science domain questions can be generalized into a TRIZ-informed ontology-based data model and established answer patterns that can be applied towards a wide variety of specific questions. In a more general embodiment, (instead of TRIZ-informed matrix and logic), semantic technology methods are used to perform the same function(s).

### BRIEF DESCRIPTION OF THE DRAWINGS

For a fuller understanding of the invention, reference is made to the following description taken in connection with the accompanying drawings in which:

FIG. 1: Depicts the general architecture diagram of the invention. Comprising of five major components and 25 sub-components. The major components are: (1) question extractor, (2) call and response engine, (3) question solver, (4) ontology-based data bank(s), and (5) tools and administrative.

FIG. 2: Depicts an example the question extractor in a structured data embodiment.

FIG. 3: Depicts Call and Response architecture in a structured data embodiment.

FIG. 4: Depicts Call and Response Data Model in a structured data embodiment;

FIG. 5: Depicts the processing chain the present invention uses when deriving business-specific answers from user input of question or autonomous-cognition derived question statements. The processing chain is broken down based on the three main modules: Question Extractor (steps 1 and 2), Call and Response Engine (steps 3 and 4), and Question Solver (step 5). Step 6 describes the iterative and self-improving nature of the present invention. Each step represents a discrete processing stage.

FIG. 6: Depicts the processing chain for the initial setup.

FIG. 7: Depicts an appliance-based Identity Clearinghouse implementation for the Transportation Security Agency (TSA) airport passenger screening.

FIG. 8: Depicts the four use cases described in the example.

FIG. 9: Depicts the Federated Search Engine Management leveraging the present invention when multiple ontology-based search engine instances are implemented in a distributed manner for the purposes of (a) authority of content, (2) scalability, (3) integration of public and/or private knowledge, (4) information security or privacy, (5) language differences, (6) geographical disbursement, or any other business or scientific reason.

FIG. 10: Depicts the technical architecture of the invention. Comprised of the following major components: presentation, ontology search, fusion logic, index, store, categorize, discover, and data sources.

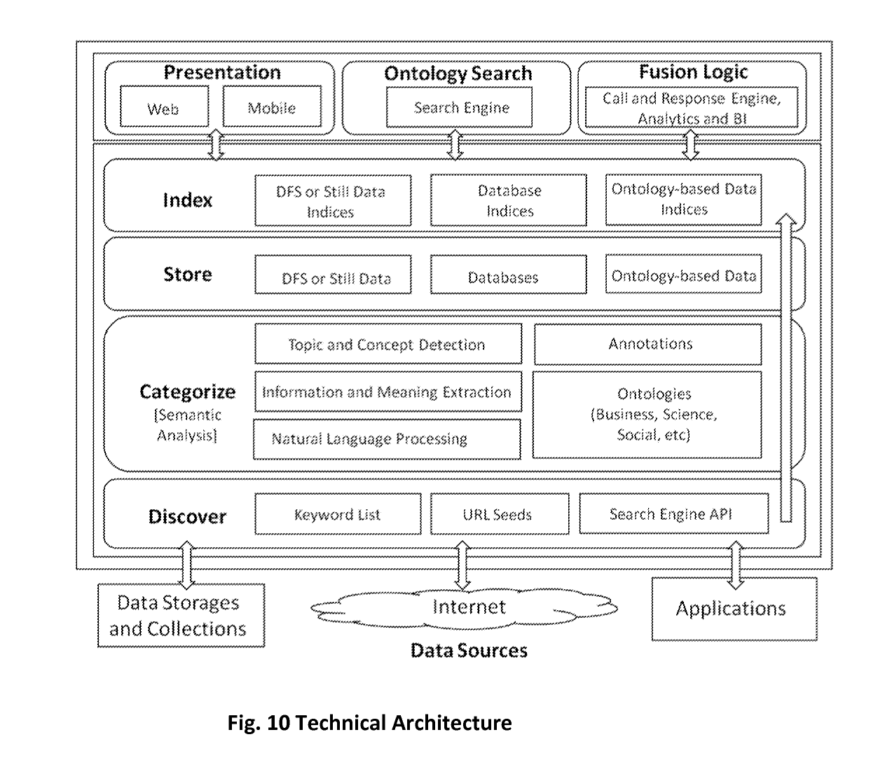

### DETAILED DESCRIPTION OF THE PREFERRED EMBODIMENTS

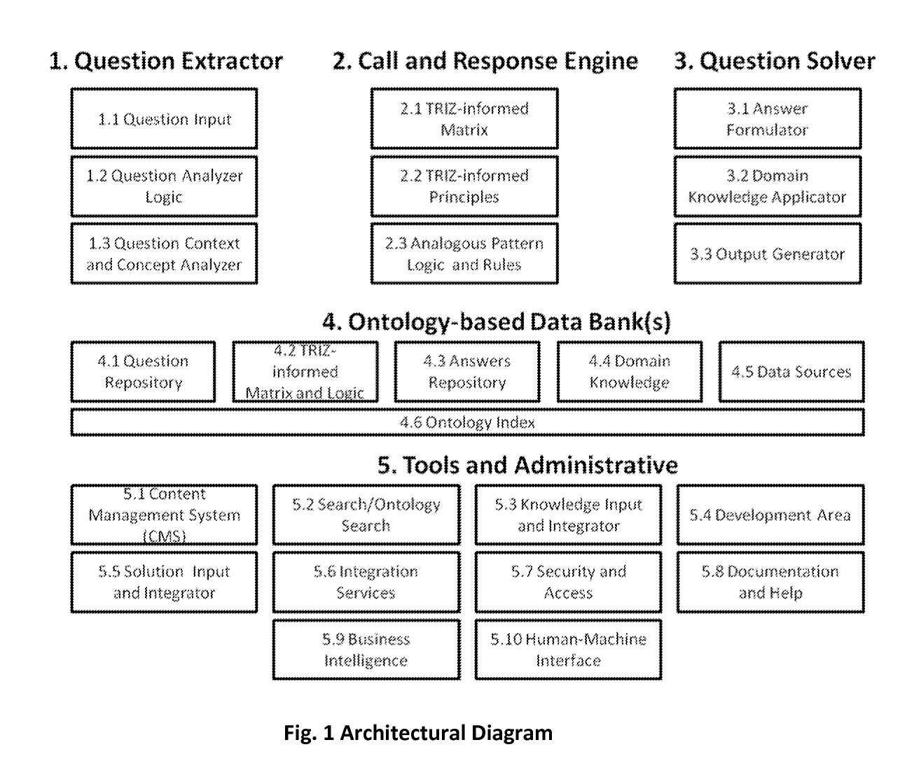

The representative embodiment of the architecture of the present invention is described in FIG. 1.

Question Extractor.

The representative embodiment of the present invention includes a Question Extractor. In one embodiment, the Question Extractor can be a human-computer interface for inputting structured data query. In another embodiment, the Question Extractor uses semantic technologies methods and tools (e.g. Natural Language Processing (NLP), ontology, Reasoner) to formulate the question(s) of interest in the system. The user enters a description of a system question under consideration. The description of the system is written in natural language notation, in any language supported by the present invention. The problem is annotated by the present invention into RDF triples (subject-predicate-object expressions). The description of the question is stored in a memory device in the form of an ontology-based Question Descriptor. When structured data is used, the memory device can be in the form of a relational database Question Descriptor.

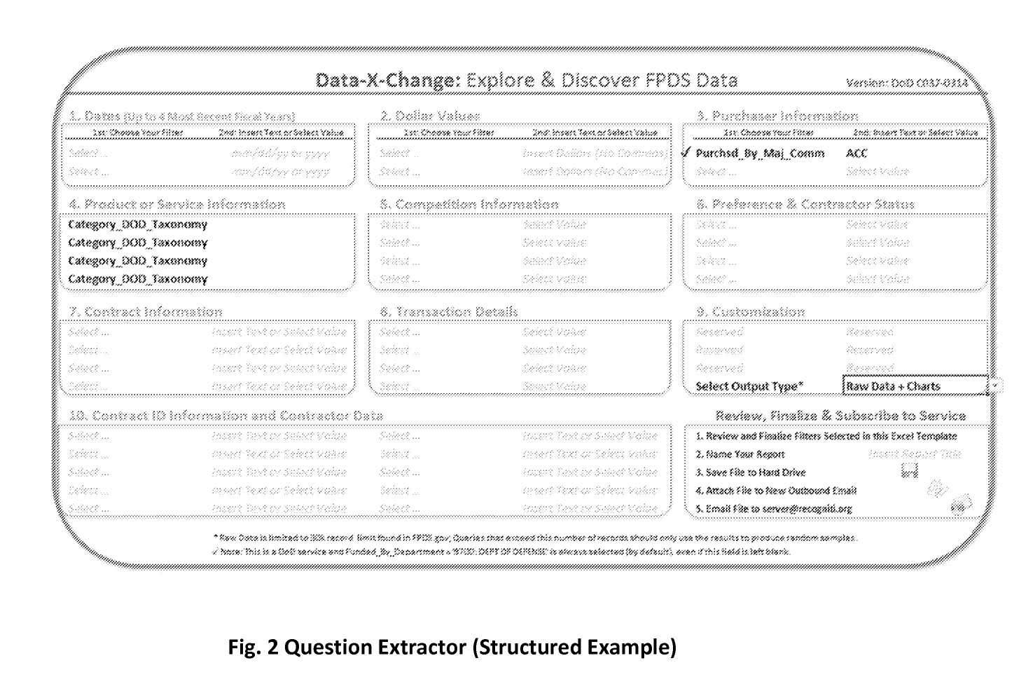

An example of a structured Question Extractor in Excel is shown in FIG. 2. The Excel data is validated based on the correct values in the targeted system.

A Question Pattern Checker verifies the completeness of the description of the system question. The present invention analyzes the Descriptor to determine if the Descriptor represents one or more questions in the system under consideration and to determine if the description of the system is logically consistent and complete based on the requirements of the Call and Response Engine. Additionally, a visual representation of the Descriptor can be displayed to the user on the human-machine interface.

The Question Extractor can also be used to identify questions in a system. This is referred to as Implicit Cognition or Autonomous-Cognition.

Call and Response Engine.

The present invention forms the basis of a computer-based technological question-answer system.

In one embodiment, the present invention's Call and Response Engine is a messaging system for asynchronous processing of “call” messages containing specific query, processing this query, and packaging the results from the call query into a “response” in raw data or in a form for analysis or intelligence modeling.

In another embodiment, the present invention utilizes TRIZ model. The present invention does not utilize the traditional TRIZ model and ARIZ algorithm, but rather, new problem solving algorithms that are suitable for computer implementation and execution.

Based on the question parameters (call), TRIZ-informed metrics and principles for the specific domain of interest are applied to identify (response) analogous (generic) answers. The knowledge itself is stored in the ontology-based data bank(s). Note that in a more general embodiment, (instead of TRIZ-informed matrix and logic), semantic technology methods are used to perform the same function.

Question Solver.

The representative embodiment of the present invention also includes a Question Solver. The Question Solver, at its highest level, is a computer-based apparatus for answering business or science questions.

In one embodiment, the Question Solver is the logic that “extracts” the request from the “call” message and converts it into appropriate data query request (e.g. SQL query to the reference database(s)). The processing steps are explained in the section below.

In another embodiment, the user inputs a question statement. As a result, through this process and knowledge stored in the ontology-based search engine, the Question Solver can define answers within the specific domain of business or science. Further logic refines the formulated solutions before the output is generated.

In addition, new systems can be synthesized. The Question Solver of the present invention allows a user to explore the answer “space” in much greater detail and with much more focus. Rather than just considering generalized answers, which are often highly abstract at best, the present invention provides specific focused answers to the inputted question. Further, the Question Solver presents the user with answer analogies that have a significant likelihood of being relevant to the question under consideration. Often these analogies would not otherwise be obvious or known to the user as they originate from a completely separate business of scientific domain.

Ontology-Based Data Bank(s).

Five logical or connected physical ontology-based data repositories exist: (1) Question Repository, (2) Call and Response Logic, (3) Answer Repository, (4) Domain Knowledge, and (5) Data Sources. The ontology is constantly expanded and the underlying ontology index updated. In one embodiment, the present invention can be deployed in public domain for the use of all Internet users. In another embodiment, the present invention can be deployed in a private instance for the needs of a specific Organization.

During the normal course of operation, the present invention rank-orders the Data Sources and the individual contributors of knowledge based on number of times source and content data asset have been used in an answer. In one embodiment, this allows the present to maintain a contribution score for subject matter experts (SME-score).

Tools and Administrative.

Refers to the tools/administrative sub-modules and functions of the present invention.

### Processing Architecture

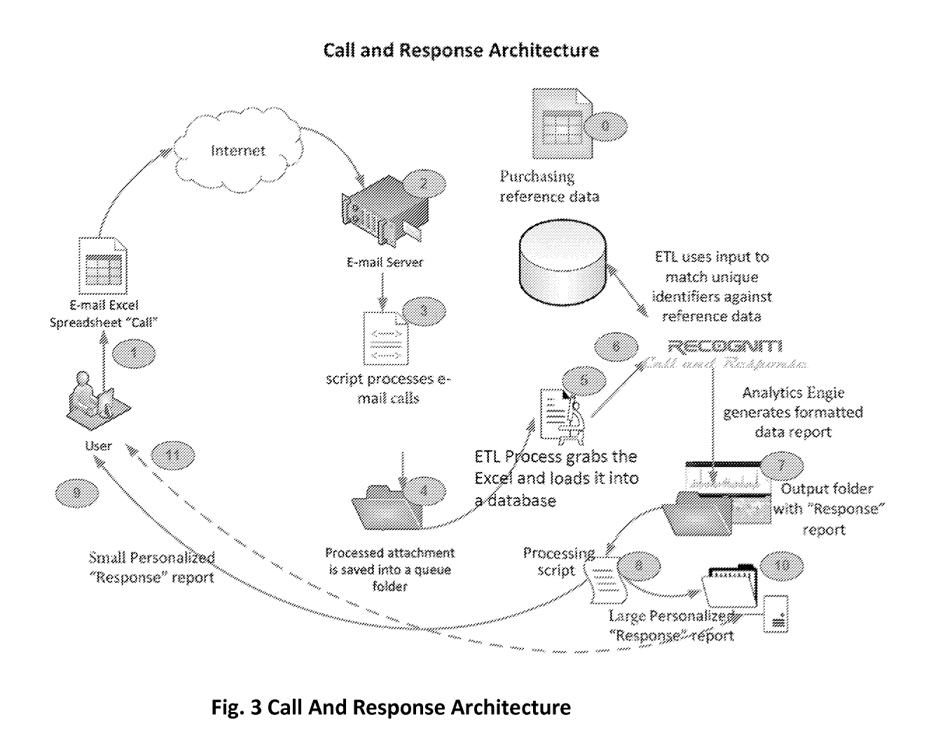

FIG. 3 describes the Call and Response Architecture for embodiment of the present invention's Call and Response Engine is a messaging system for asynchronous processing of “call” messages containing specific query, processing this query, and packaging the results from the call query into a “response” in raw data or in a form for analysis or intelligence modeling. The steps are described below:
Step 0: Initial Load—purchasing (FPDS) reference data feed is loaded and refreshed on a scheduled basis; this process is automated and is monitored by the Recogniti Team via real-time warnings and alerts
Step 1: User of the Database “Call and Response” Service prepares and emails spreadsheet “Call”
Step 2: E-mail Server receives the email containing the “Call” spreadsheet
Step 3: script processes the Excel e-mail attachment, as well as retrieves details like sender e-mail address, date received
Step 4: Processed attachment is saved into a queue folder and awaiting further processing
Step 5: ETL processes grabs Excel input from folder and loads it into the “Call and Response” database
Step 6: ETL uses input to match unique identifiers against purchasing (FPDS) reference data
Step 7: Analytics generates formatted data “Response” report with visualizations; report is stored into the Output folder
Step 8: Processing script picks up the “Response” report from the Output folder; If report file size is smaller than 25 MB:
Step 9: User receives the personalized “Response” report via email If report file size is larger than 25 MB:
Step 10: Personalized “Response” report is saved to an SFTP server
Step 11: User receives a notification email that their personalized report is ready; user retrieves the report from the SFTP server

The Java code used for the steps above is provided below. Note that some of the functions are in pseudo format and are easily replicatable with average skill in the art. The technical architecture is composed of Apache Tomcat, MySQL, business intelligence, SFTP, and SMTP, IMAP.

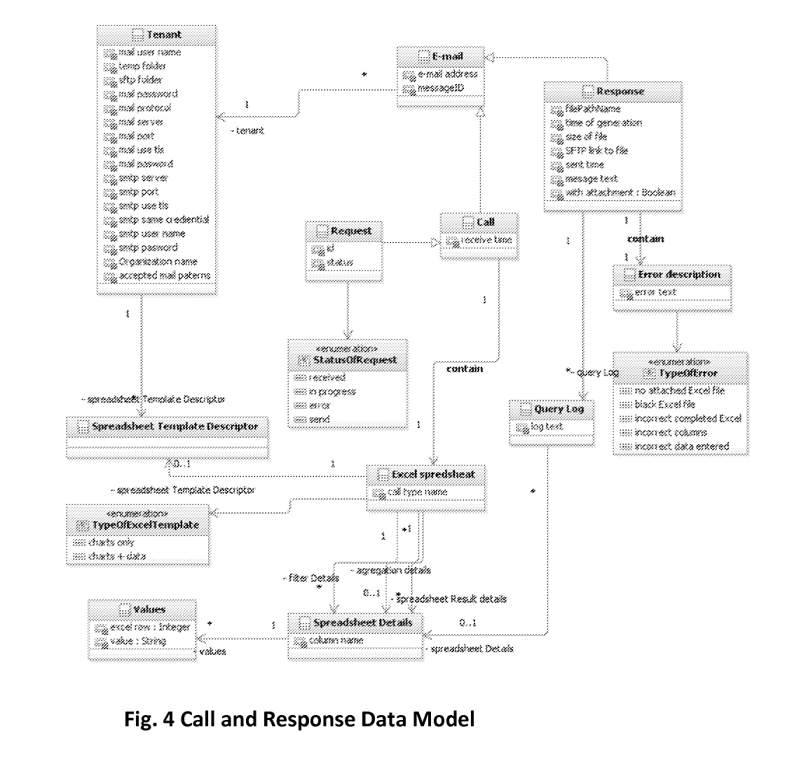

The data model for this embodiment is depicted in FIG. 4.

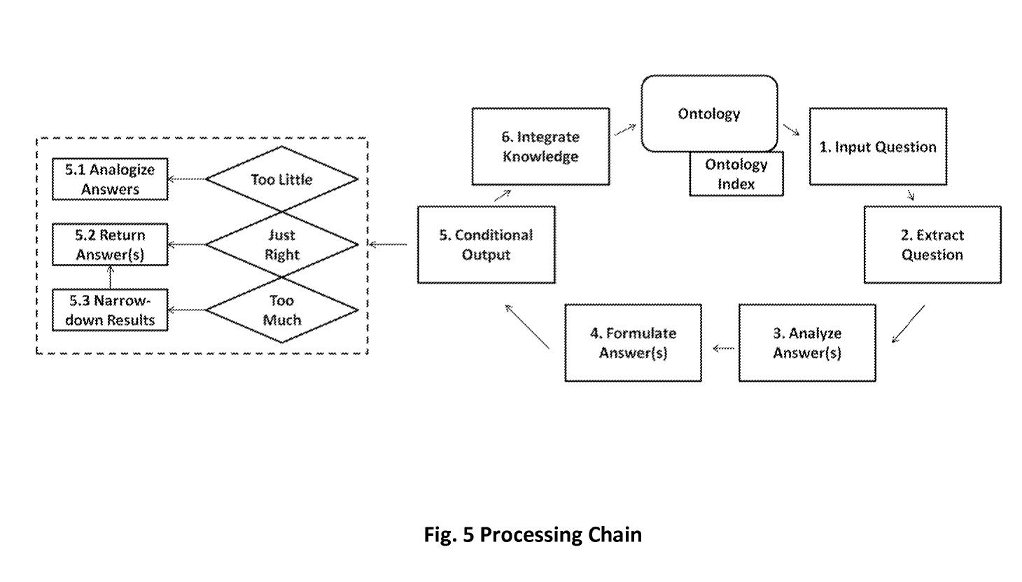

FIG. 5 conceptually depicts the processing chain in another non-structured data embodiment when the present invention uses when deriving business-specific answers from user input of question or autonomous-cognition derived question statements. The processing chain is broken down based on the three main modules: Question Extractor (steps 1 and 2), Call and Response Engine (steps 3 and 4), and Question Solver (step 5). Step 6 describes the iterative and self-improving nature of the present invention. Each step represents a discrete processing stage.
1. Input Question. The present invention provides a machine-assisted interface for users of the invention to input, into the system's question of interest. The question doesn't have to be inputted in a traditional question format. The present invention will interpret any input as a query of interest. The domain of business or science is defined here. In addition, in a specific embodiment, question statement can be derived based on autonomous-cognition.
2. Extract Question. Subject matter experts frequently do not understand well the question at hand and spend their limited resources answering a wrong question. The Question Extractor identifies problems in a system by using semantic technologies (e.g. natural language processing (NLP), ontology) to extract question parameters from the question statement. This processing step formulates the question into RDF triples (subject-predicate-object expressions). The question extraction is done based on a pre-defined question definition “shell.” This enables the present invention to expand and/or refine the inputted question when it is not fully defined or when further refinement is needed. The information extracted from the question statement is compared with the Question Repository of previously inputted questions and is integrated for future user searches. Based on the defined RDF triples, the question statement(s) are translated into TRIZ-informed call which in turn is used by the Question Solver to respond with output back to the user. A question Context and Concept Analyzer validates the question formulation and queries for additional knowledge/input related to the question. Note that in a more general embodiment, (instead of TRIZ-informed matrix and logic), semantic technology methods are used to perform the same function(s). The present invention searches for additional supporting domain to further characterize the question.
3. Analyze Answers. The pertinent question parameters are inputted into the Call and Response Engine to identify known answers. The Analyze Answers leverages TRIZ-informed principles to identify analogous answers to the business or science question of interest. Typically, questions tend to appear in patterns with high degree of analogy between business and science domains (e.g. economics, supply and demand theory, and outthinking intelligent adversary, where similar principles from the economics domain influence the adversarial behavior). [1] The answers to those questions predictably follow such patterns in a business context. The TRIZ-informed principles and logic in the present invention are adapted from the original engineering and Business TRIZ problem solver principles. Note that in a more general embodiment, (instead of TRIZ-informed matrix and logic), semantic technology methods are used to perform the same function(s). [1] http://mie.umass.edu/news/new-com pany-perfects-science-inventiveness
The Call and Response Engine module of the present invention enables a question to be classified, contextualized and answered quickly, efficiently, and comprehensively allowing the Organization and the Subject Matter Experts to focus in areas where true innovation is needed and leverage analogous answers and knowledge where they exist.
4. Formulate Answers. The output of the question analysis processing step is used by the TRIZ-informed domain ontology-based data bank to produce a set of answers—domain specific or analogous. The answers are derived from already established business practices and principles, as they exist in the ontology and logic. Note that in a more general embodiment, (instead of TRIZ-informed matrix and logic), semantic technology methods are used to perform the same function(s).
Outputted analogous answers are integrated with domain specific context and concepts. This integration is done by intelligent ontology-driven data model for gathering, integrating and retrieving knowledge. Further logic refines the formulated answers before the output is generated.
5. Conditional Output. In this machine-assisted interface for user display, outputs are generated back to the user. In one embodiment, a web-based interface of the search engine is used for question input and answers output.
   Conditional Output sub-steps, based on the amount and volume of formulated answer set include:
   Too Little. When the answer set does not contain any answers or only few that are relevant, the present invention analogizes answers from other domains of business or science and presents them to the user. In addition, the present invention stores the unanswered question and looks for content in the Data Sources to supplement and fill in the knowledge gaps.
   Just Right. Answers are returned back to the user in the order of relevance. Relevance score is calculated based on relevancy algorithms, such as open source Sphinx relevancy engine.
   Too Much. When answer set is too long, ontology-based relevancy algorithms are used to rank order the answers and display back to the user.
6. Integrate Knowledge. This processing step expands the ontology/data repository with new knowledge. The logical data repositories been updated include: (a) Question Repository, (b) TRIZ-informed Matrix and Logic, (c) Answers Repository, and (d) Domain Knowledge. In addition, in one embodiment, the present invention can be implemented in a private deployment, where an Organization can leverage institutional or other paid/proprietary knowledge. Such deployment may require appliance-based deployment architecture. Note that in a more general embodiment, the TRIZ-informed matrix and logic is referred to as Ontology Matrix and Logic repository.

### Initial Setup

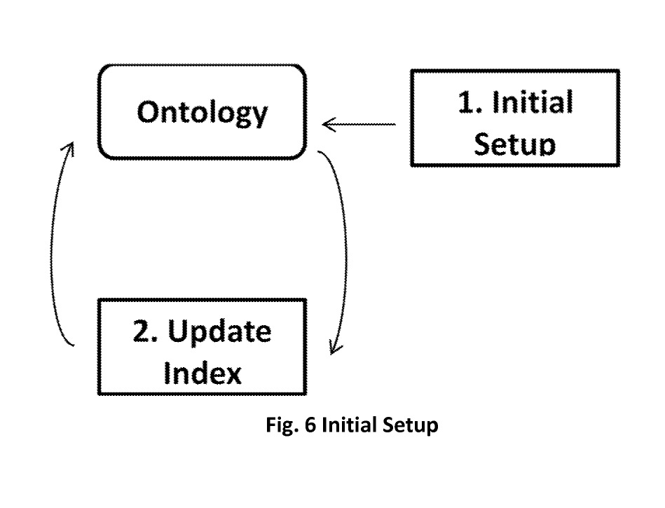

FIG. 6 describes the processing chain for the initial setup when the present invention is implemented in an for unstructured context. When the present invention is implemented in a structured data construct, the initial setup is comprised predominantly of the steps for data mapping and validation.
Ontology. The ontology is stored in an ontology data bank, which is non-relational in nature. As the present invention integrates additional knowledge about questions, logic, answers, domain knowledge, context and concepts, this may require a constant schema change in a relational database as the data model expands. Such changes are hard to implement in a relational databases and in a common embodiment, the present invention is implemented based on an ontological data model.
The physical implementation of the ontology data bank of the present invention according to a preferred embodiment is based on an ontology-based data model.
1. Initial Setup. In this step all initial configuration and setup of the present invention is completed.
2. Update Index. In this step, the index enabling search and intelligent retrieval of information from the Ontology is updated.

### CASE STUDIES

### Examples

This section contains several examples for illustrative purposes of how the present invention can be used. At a high level, the present invention can be applied to (1) perform contextual and concept-driven searches in domains of business and science and (2) integrate and retrieve knowledge and perform adaptive classification, integration and retrieval of problem patterns and analogous solutions cross various business and science domains.

The following case studies are representative case study embodiments of the present invention.

### Case Study 1: Clearinghouse for Purchasing Data

In this case study, the present invention is deployed as a clearinghouse to facilitate user inquiries into large data set containing purchasing data. The specific dataset is comprised of eight (8) years of FDPS government official procurement data with approximate size as of the time of submission of this application 35 GB. There are 35,000 users within the Department of Defense (DoD) alone who need to perform complex data queries and analysis daily—many of such queries requiring the aggregation of millions of records. Traditional query systems are not practical in this case since lack of efficient scalability due to requiring enormous amounts of resources to be allocated without any upside gain for the user (typical query takes several hours to process requiring resource allocation to users who are waiting for response to their query.

The proposed invention is highly effective in handling this case study scenario since all user calls are ordered in a messaging queue and no system resources are allocated and wasted until the system is ready to process the request. Multiple threats enable parallel processing of multiple simultaneous calls, as well as each call can be paralyzed for accelerated processing, as well.

The processing steps for this case study are described in FIG. 3, steps 0-11 and the provided above Java code.

### Case Study 2: Clearinghouse for Identity Data

The processing steps and code are the same as for Case Study 1, with the following exceptions: Input is via Secured Flight Passenger Data (and not via an Excel sheet). The response is in the form of a number between 0 and 1 for the purposes of determining a binary “Yes” or “No” output based on a pre-set threshold.

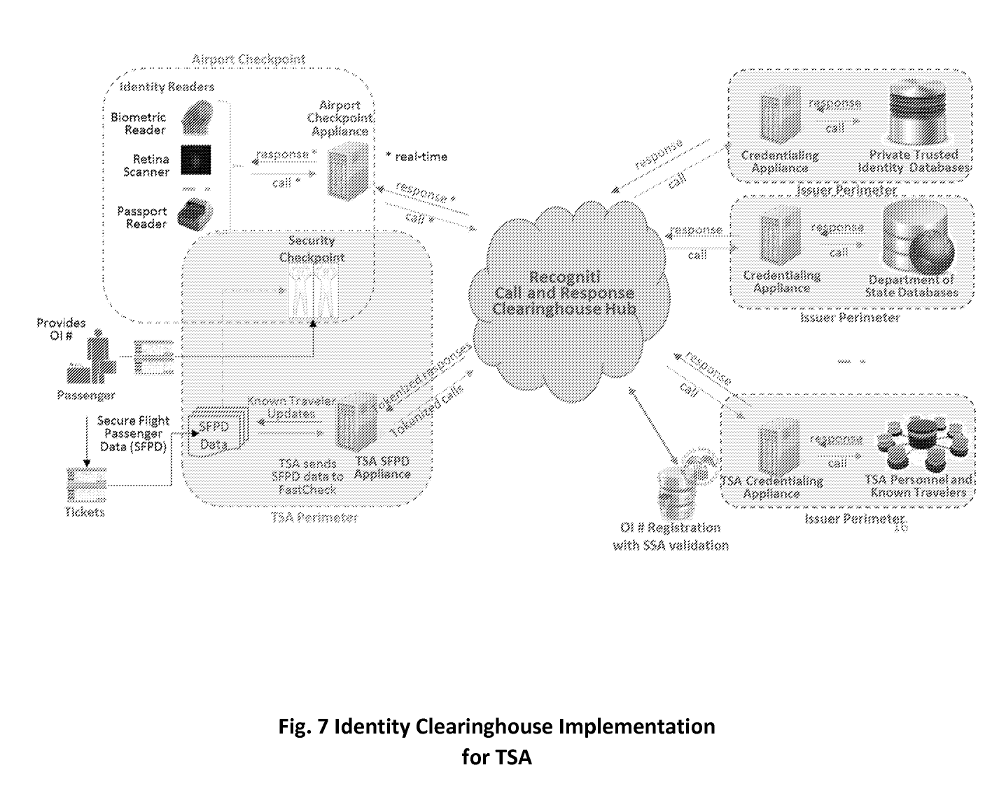

FIG. 7 depicts a functional architecture of the present invention deployed as an Identity Clearinghouse for the Transportation Security Agency (TSA) airport security. This implementation of the present invention is based on a secured appliance-based network implementation.

In this embodiment, the Clearinghouse Call and Response Hub acts as the Control Center for the collective of appliances. Passenger data is provided to TSA on regular intervals (days) prior to the flight date/time. Once the Secure Flight Passenger Data (SFPD) is received by TSA, in the same format it is sent to the TSA SFPD appliance which tokenizes the data into one message per passenger travel event. This constitutes the Calls. Each call is then sent from the TSA SFPD Appliance to the Control Center (i.e. the Call and Response Hub). Once received, each call is queued in the Clearinghouse Hub and two functions are performed: (1) passenger identity is determined, (2) new or existing call is determined, and (3) per business logic message(s) to one or more of the pre-approved by TSA trusted identity databases. If (1) is unsuccessful (meaning passenger identity cannot be confirmed, messages is sent back to the TSA with a passenger eligibility for pre-clearance=“No.”

The sent in (3) calls are received by the respective credentialing appliances, and passengers are checked against, for instance criminal databases, government security clearances, bio-bank, etc. Based on the pre-determined by TSA rules, passenger determination for pre-clearance eligibility is determined and sent as response back to the Call and Response Hub, and ultimately to the TSA SFPD appliance.

### Case Study 3: Ontology-Based Search Engine

The present invention can be deployed as a platform to index, search, retrieve, filter, integrate and serve information. Traditional search engines (such as Google, Bing, Yahoo) utilize keywords as a main mechanism to search information. It is common that the keyword-based search misses highly relevant data and returns a lot of irrelevant data, since the keyword-based search is ignorant of the type of resources that have been searched and the semantic relationships between the resources and keywords. In order to effectively retrieve the most relevant top-k resources in searching in the Semantic Web, some approaches include ranking models using the ontology which presents the meaning of resources and the relationships among them. This ensures effective and accurate data retrieval from the ontology data repository.

The representative embodiment of the present invention is described below:

Question Extractor. In the representative embodiment, the present invention is deployed on a website (public or private). Much like with Google, the user enters search criteria in a free-text natural language notation in English or any other supported language. Information Extraction algorithms and other semantic technologies (e.g. Natural Language Processing (NLP), Ontology, Reasoner, RDF) are used to identify what the user is looking for. This is augmented by user specific profile, such as behavior, location, segmentation, or other purposeful attributes. The Question Extractor defines the Question Descriptor, which is a coherent description of the search context and concept of interest.

In addition, search criteria is seamlessly integrated into the underlying ontology-based data model, which makes the search engine “smarter” and more accurate over time.

Call and Response Engine. The underlying TRIZ-informed matrix in this embodiment is used predominantly to classify and contextualize the Question Descriptor and match it with relevant answers. Note that in a more general embodiment, (instead of TRIZ-informed matrix and logic), semantic technology methods are used to perform the same function(s). Pattern based algorithms, meta knowledge, and logic are indexed and constantly improved and augmented with new data assets (for example, from Google index, social media data integrator, news aggregator, patent office data, and any other source of data referenced in the Data Source repository). Data types can be text, image, audio, video, locator, sensor, and any other created or detected structured or unstructured information. The present invention integrates into the underlying ontology data model knowledge, meta knowledge and logic continuously based on the user searches, and over time becomes “smarter” and more accurate.

Question Solver. In this representative embodiment, the search request is received, and the Problem Solver searches the underlying ontology-data index and retrieves relevant and context-informed answers. The human-machine interface presents the answers back to the user.

Problem Solver constantly integrates additional data into the index of the underlying ontology-based data model from the Data Sources, such as Google index, social media data integrator, news aggregator, patent office data, and any other data source. This makes the Question Solver “smarter” and more accurate over time.

Ontology-based Data Bank(s). The data model of this representative embodiment consists of five logical or connected physical data repositories: (1) Question Repository (or Query Repository), (2) TRIZ-informed Matrix Logic, (3) Answer Repository, (4) Domain Knowledge (or Context and Concept Repository), and (5) Data Sources. In one embodiment, these repositories are implemented in a single physical ontology-based data model. In another embodiment, the data repositories can be deployed in physically separated machines and an appliance-based approach may be preferred. Note that in a more general embodiment, the TRIZ-informed Matrix and Logic is referred to as Ontology Matrix and Logic repository.

Irrespective of the deployment of the present invention, the Ontology and Ontology Index are constantly expanded and updated as part of the normal operations of the present invention.

Example Practical Implementation

Let's consider an example where the Ontology-based Search Engine is used by an organization to keep its personnel compliant with the latest IT requirements with a task to obtain and maintain certificates in the knowledge areas of Service Oriented Architecture (SOA) and Cloud Computing. The goal of the organization is to set up the inventive system to: (A) improve information/knowledge integration; and (B) improve information/knowledge retrieval. For illustrative purposes, this example focuses on two knowledge topics: (1) Service Oriented Architecture (SOA) and (2) Cloud Computing.

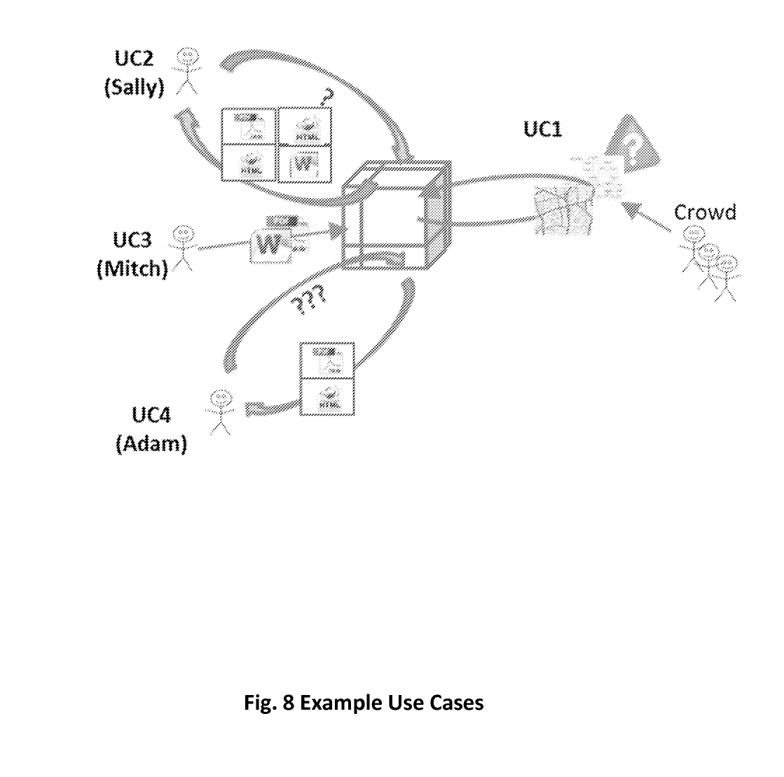

The following use cases are considered (FIG. 8):
UC1. Traditionally, the organization doesn't have a systematic and automated way to data mine pertinent SOA and Cloud Computing information. This results in duplicate, inefficient effort and is subject to individual limitations and biases. The inventive system searches external SOA and Cloud Computing knowledge repositories, patent filings, scientific publications, product information, technical specifications, etc. and retrieves and integrates relevant knowledge into the organization's knowledge base.
UC2. Sally, expert in SOA with 10-years of experience, knows what she doesn't know and knows where to find it. This allows her to query the existing knowledge base for information. This traditionally has resulted in information overload. The present invention helps her refine the results of the query from the same knowledge base and only present the relevant information—exactly what she needs, when she needs it and in a readily accessible format.
UC3. Mitch, a published expert in the field with 25-years of experience, knows what he knows. He is familiar with what is relevant to others in the organization and contributes his knowledge regularly. Although he spends a considerable amount of time daily, this traditionally has resulted in little impact to the organization due to inability to consistently distribute and make readily accessible this knowledge. The present invention helps Mitch integrate his knowledge and make it readily accessible to Sally and all other users, when needed. The present invention can help Mitch accomplish this in two ways—fully-automated, when Mitch contributes knowledge to the organization's knowledge exchange and the inventive system integrates it automatically into the knowledge base, or semi-automated, when Mitch contributes knowledge to the inventive system by actively entering it into the knowledge base through the system interface. For illustrative purposes, only the fully automated way is addressed herein as the semi-automated way can be viewed as subset.
UC4. Adam, recent graduate and newest member of the organization with no experience, doesn't know what SOA and Cloud Computing information exists, but he (and the organization) will greatly benefit from it. Traditionally, new hires spend considerable amount of time in learning the sources and going through the content for knowledge and relevance to get ready for independent work assignments. The present invention helps Adam refine what his queries should be and makes all organizational knowledge available to Adam in a structured and systematically organized format-exactly what he needs, when he needs it and in a readily accessible format.

As an example of a practical implementation, first, an individual of the OntologyUniverse class is created (this is representing the ontology itself). Four subclasses of the LearningRequirementDimension class are created: NeedToKnow, Education, Experience. NeedToKnow has individuals Mandatory, CareerAdvancement, QuestForKnowledge. Education has individuals ES (elementary school), HS (high school), BS (bachelor's degree), MS (master's degree), PhD. Experience has individuals None, Some, Advanced, Expert. Each one of the five sample individuals of the class Requirement is characterized with three LearningRequirementDimension as shown in the Elements Created Table 1. Not all combinations of the values of the three LearningRequirementDimension are used:

TABLE 1

| Label | Elements Created |
|---|---|
| A | OntologyUniverse consistsOfRequirement |

Learning_Requirement_1
Learning_Requirement_2
Learning_Requirement_3
Learning_Requirement_4
Learning_Requirement_5

| | |
|---|---|
| B | LearningRequirementDimension |

NeedToKnow

Mandatory
CareerAdvancement
QuestForKnowelge

Education

ES
HS
BS
MS
PhD

Experience

None
Some
Advanced
Expert

| | | | |
|---|---|---|---|
| C | Learning_Requirement_1 | hasLearningRequirementDimension | Mandatory |

| | |
|---|---|
| hasLearningRequirementDimension | BS |
| hasLearningRequirementDimension | Some |

| | | |
|---|---|---|
| Learning_Requirement_2 | hasLearningRequirementDimension | CareerAdvancement |

| | |
|---|---|
| hasLearningRequirementDimension | ES |
| hasLearningRequirementDimension | None |

| | | |
|---|---|---|
| Learning_Requirement_3 | hasLearningRequirementDimension | QuestForKnowelge |

| | |
|---|---|
| hasLearningRequirementDimension | BS |
| hasLearningRequirementDimension | Advanced |

| | | |
|---|---|---|
| Learning_Requirement_4 | hasLearningRequirementDimension | Mandatory |

| | |
|---|---|
| hasLearningRequirementDimension | ES |
| hasLearningRequirementDimension | Some |

| | | |
|---|---|---|
| Learning_Requirement_5 | hasLearningRequirementDimension | CareerAdvancement |

| | |
|---|---|
| hasLearningRequirementDimension | MS |
| hasLearningRequirementDimension | Expert |

| | |
|---|---|
| E | Requirement Learning_Requirement_5 consistsOf |

CloudComputing_Certificate
SOA_Certificate

| | |
|---|---|
| G | Knowledge |

| | |
|---|---|
| CloudComputing_Certificate hasComponent | CloudHardware |
| CloudComputing_Certificate hasComponent | CloudSoftware |
| CloudComputing_Certificate hasComponent | CloudSupportTools |

| | |
|---|---|
| SOA_Certificate hasComponent | SOAP |
| SOA_Certificate hasComponent | WSDL |
| SOA_Certificate hasComponent | BPEL |

| | |
|---|---|
| H | ValueUnitType |

| | | |
|---|---|---|
| Time | aggregationType | Sum |
| | measuringUnit | minutes |
| | isOrdinal | true |
| | isProgressive | true |

| | | |
|---|---|---|
| Precision | aggregationType | MAP (macro average precision) |

| | | |
|---|---|---|
| | measuringUnit | 1 |
| | isOrdinal | true |
| | isProgressive | false |
| Recall | aggregationType | MAR (macro average recall) |
| | measuringUnit | 1 |
| | isOrdinal | true |
| | isProgressive | false |

| | |
|---|---|
| I | ValueUnit |

| | | |
|---|---|---|
| CloudHardware_RetrievalTime | hasType | Time |

| | |
|---|---|
| hasValue | 0.3 |

| | | |
|---|---|---|
| CloudHardware_Precision | hasType | Precision |

| | |
|---|---|
| hasValue | 0.8 |

| | | |
|---|---|---|
| CloudHardware_Recall | hasType | Recall |

| | |
|---|---|
| hasValue | 0.9 |

| | | |
|---|---|---|
| CloudSoftware_RetrievalTime | hasType | Time |

| | |
|---|---|
| hasValue | 0.2 |

| | | |
|---|---|---|
| CloudSoftware_Precision | hasType | Precision |

| | |
|---|---|
| hasValue | 0.85 |

| | | |
|---|---|---|
| CloudSoftware_Recall | hasType | Recall |

| | |
|---|---|
| hasValue | 0.85 |

| | | |
|---|---|---|
| CloudSupportTools_RetrievalTime | hasType | Time |

| | |
|---|---|
| hasValue | 0.4 |

| | | |
|---|---|---|
| CloudSupportTools_Precision | hasType | Precision |

| | |
|---|---|
| hasValue | 0.75 |

| | | |
|---|---|---|
| CloudSupportTools_Recall | hasType | Recall |

| | |
|---|---|
| hasValue | 0.95 |

| | | |
|---|---|---|
| SOAP_RetrievalTime | hasType | Time |

| | |
|---|---|
| hasValue | 0.1 |

| | |
|---|---|
| SOAP_Precision hasType | Precision |

| | hasValue | 0.9 |
|---|---|---|
| SOAP_Recall | hasType | Recall |

| | |
|---|---|
| hasValue | 0.75 |

| | | |
|---|---|---|
| WSDL_RetrievalTime | hasType | Time |

| | hasValue | 0.1 |
|---|---|---|
| WSDL_Precision | hasType | Precision |
| | hasValue | 0.8 |
| WSDL_Recall | hasType | Recall |

| | |
|---|---|
| hasValue | 0.95 |

| | | |
|---|---|---|
| BPEL_RetrievalTime | hasType | Time |

| | |
|---|---|
| hasValue | 0.5 |

| | |
|---|---|
| BPEL_Precision hasType | Precision |

| | hasValue | 0.95 |
|---|---|---|
| BPEL_Recall | hasType | Recall |

| | |
|---|---|
| hasValue | 0.95 |

| | |
|---|---|
| J | Component |

| CloudHardware | hasValueUnit | CloudHardware_RetrievalTime |
|---|---|---|
| | hasValueUnit | CloudHardware_Precision |
| | hasValueUnit | CloudHardware_Recall |
| CloudSoftware | hasValueUnit | CloudSoftware_RetrievalTime |

| | |
|---|---|
| hasValueUnit | CloudSoftware_Precision |
| hasValueUnit | CloudSoftware_Recall |

| | | |
|---|---|---|
| CloudSupportTools | hasValueUnit | CloudSupportTools_RetrievalTime |

| | hasValueUnit | CloudSupportTools_Precision |
|---|---|---|
| | hasValueUnit | CloudSupportTools_Recall |
| SOAP | hasValueUnit | SOAP_RetrievalTime |
| | hasValueUnit | SOAP_Precision |
| | hasValueUnit | SOAP_Recall |
| WSDL | hasValueUnit | WSDL_RetrievalTime |
| | hasValueUnit | WSDL_Precision |
| | hasValueUnit | WSDL_Recall |
| BPEL | hasValueUnit | BPEL_RetrievalTime |

| | |
|---|---|
| hasValueUnit | BPEL_Precision |
| hasValueUnit | BPEL Recall |

From row E and on, the focus is on one Requirement: Learning_Requirement_{—}5.

Two individuals of the class Knowledge are identified. For each Knowledge, its Components are also identified as shown in Table 1 row G. Value Unit Types and Value Units are defined as shown in Table 1 rows H and I.

In this example, two responses are illustrated—EfficientReverselndexing (Resp1) and “DoubleRedundancy” (Resp2). The responses match the calls and improve information retrieval times. Table 2 Responses below defines the setup values.

TABLE 2

| Label | Elements Created |
|---|---|
| A | Capability subclassOf Dimension |

| | | |
|---|---|---|
| EfficientReverseIndexing | hasCost | $1 |
| DoubleRedundancy | hasCost | $1.5 |

| | |
|---|---|
| B | Component |

| | | |
|---|---|---|
| CloudHardware | hasValueUnit | CloudHardware_RetrievalTime |

| | |
|---|---|
| hasValueUnit | CloudHardware_RetrievalTime_Resp1 |
| hasValueUnit | CloudHardware_RetrievalTime_Resp2 |
| hasValueUnit | CloudHardware_RetrievalTime_Resp1&2 |

| | |
|---|---|
| C | ValueUnit |

| | | |
|---|---|---|
| CloudHardware_RetrievalTime _Resp1 | hasType | Time |

| | |
|---|---|
| hasValue | 0.2 |
| hasDimension | EfficientReverseIndexing |

| | | |
|---|---|---|
| CloudHardware_RetrievalTime _Resp2 | hasType | Time |

| | |
|---|---|
| hasValue | 0.1 |
| hasDimension | DoubleRedundancy |

| | | |
|---|---|---|
| CloudHardware_RetrievalTime _Resp1&2 | hasType | Time |

| | |
|---|---|
| hasValue | 0.08 |
| hasDimension | EfficientReverseIndexing |
| hasDimension | DoubleRedundancy |

Based on the created data elements (Table 1 and Table 2), the following values are computed (Table 3, Computed Values):

TABLE 3

| | Data | | | | Formula |
|---|---|---|---|---|---|
| Label | Element | Element | | Computed Value | used |
| D | Value Unit | CloudHardware_RetrievalTime | | 0.291313 | A |
| | Criticality | CloudSoftware_RetrievalTime | | 0.197375 | |
| | | CloudSupportTools_RetrievalTime | | 0.379949 | |
| | | SOAP_RetrievalTime | | 0.099668 | |
| | | WSDL_RetrievalTime | | 0.099668 | |
| | | BPEL_RetrievalTime | | 0.462117 | |
| | | CloudHardware_Precision | | 0.33596323 | |
| | | CloudHardware_Recall | | 0.28370213 | |
| | | CloudSoftware_Precision | | 0.30893053 | |
| | | CloudSoftware_Recall | | 0.30893053 | B |
| | | CloudSupportTools_Precision | | 0.364851048 | |
| | | CloudSupportTools_Recall | | 0.260216949 | |
| | | SOAP_Precision | | 0.28370213 | |
| | | SOAP_Recall | | 0.364851048 | |
| | | WSDL_Precision | | 0.33596323 | |
| | | WSDL_Recall | | 0.260216949 | |
| | | BPEL_Precision | | 0.260216949 | |
| | | BPEL_Recall | | 0.260216949 | |
| | Knowledge | CloudComputing_Certificate | | 2.731231417 | D |
| | Criticality | SOA_Certificate | | 2.426620255 | |
| | Call | Learning_Requirement_5 Cr | | 5.157852 | E |
| | Criticality | | | | |
| | Call | 1. | Capability added: EfficientReverseIndexing | | F |
| | Criticality | | Effect: CloudHardware_RetrievalTime is replaced with | | |
| | with | | CloudHardware_RetrievalTime _Resp1 | | |
| | Response | | OldCriticality Cr = 5.157852 | | |
| | applied | | Change in Criticality of Learning_Requirement_5: | | |
| | | | NewCriticality = OldCriticality − | | |
| | | | Criticality(CloudHardware_RetrievalTime) + | | |
| | | | Criticality(CloudHardware_RetrievalTime _Resp1) = 5.157852 − | | |
| | | | 0.291312612 + 0.19737532 = 5.063914708 | | |
| | | | Ontology contains: | | |
| | | | Learning_Requirement_5 hasCriticality CrA; | | |
| | | CrA hasCapabilityApplied EfficientReverseIndexing; | | | |
| | | CrA hasValue 5.063914708 | | | |
| | | | Learning_Requirement_5 CrA | 5.063914708 | |
| | | 2. | Capability added: DoubleRedundancy | | |
| | | | Effect: CloudHardware_RetrievalTime is replaced with | | |
| | | | CloudHardware_RetrievalTime _Resp2 | | |
| | | | Change in Criticality of Learning_Requirement_5: | | |
| | | | NewCriticality = OldCriticality − | | |
| | | | Criticality(CloudHardware_RetrievalTime) + | | |
| | | | Criticality(CloudHardware_RetrievalTime _ Resp) = 5.157852 − | | |
| | | | 0.291312612 + 0.099667995 = 4.966207383 | | |
| | | | Ontology contains: | | |
| | | | Learning_Requirement_5 hasCriticality CrB; | | |
| | | CrB hasCapabilityApplied DoubleRedundancy; | | | |
| | | CrB hasValue 4.966207383 | | | |
| | | | Learning_Requirement_5 CrB | 4.966207383 | |
| | Effectiveness | 1. | EfficientReverseIndexing hasEffectivenessIndex EI_A | | G |
| | Index | | EI_A asAppliedTo Learning_Requirement_5 | | |
| | | | EI_A hasIndexValue 0.492308 (5.157852 − 5.063914708 = | | |
| | | | 0.093937292) | | |
| | | | EfficientReverseIndexing | 0.093937292 | |
| | | 2. | DoubleRedundancy hasEffectivenessIndex EI_B | | |
| | | | EI_B asAppliedTo Learning_Requirement_5 | | |
| | | EI_B hasIndexValue 0.58308 (5.157852 − 4.966207383 = 0.191644617) | | | |
| | | | DoubleRedundancy | 0.191644617 | |
| | Efficiency | 1. | EfficientReverseIndexing hasEfficiencyIndex FI_A | | H |
| | Index | | FI_A asAppliedTo Learning_Requirement_5 | | |
| | | | FI_A hasIndexValue 0.093937292 (0.093937292/$1) | | |
| | | | EfficientReverseIndexing | 0.093937292 (1/$) | |
| | | 2. | DoubleRedundancy hasEfficiencyIndex FI_B | | |
| | | | FI_B asAppliedTo Learning_Requirement_5 | | |
| | | | EI_B hasIndexValue 0.127763078 (0.191644617/$1.5) | | |
| | | | DoubleRedundancy | 0.127763078 (1/$) | |
| | Requirement | | Learning_Requirement_5 | 0.127763078 (1/$) | I |
| | Index | | | | |

In a recomputed values, label “XSD” of the Component SOAP was added to the ontology. As a result, the precision of information retrieval precision and recall for this component went up from:

| | | |
|---|---|---|
| SOAP_Precision | hasValue | 0.9 |
| SOAP_Recall | hasValue | 0.75 |

to:

| | | |
|---|---|---|
| SOAP_Precision | hasValue | 0.95 |
| SOAP_Recall | hasValue | 0.80 |

This leads to the following changes in the Criticality of the corresponding Components, Knowledge and Call (Table 4):

TABLE 4

| Element | | Old | New | |
|---|---|---|---|---|
| Type | Element | Criticality | Criticality | Equation |
| Component | SOAP_Precision hasCriticality | 0.28370213 | 0.260216949 | B |
| Component | SOAP_Recall hasCriticality | 0.364851048 | 0.33596323 | B |
| Knowledge | SOA_Certificate hasCriticality | 2.426620255 | 2.374247256 | C |
| Call | Learning_Requirement_5 hasCriticality | 5.157852 | 5.105479001 | F |

### Recompute Values

Criticality is computed for individual value units, as well as knowledge and calls that are assigned to them.

A possible functional form for Individual Criticality (as a measure of importance) is

analytical function form for a progressive Value Unit (as a factor of measure), the corresponding individual Criticality is:

$${IndCr}_{P} ( x ) = \frac{exp ( x ) - exp ( - x )}{exp ( x ) + exp ( - x )} , \qquad A$$

for a progressive Value Unit and

$${IndCr}_{R} ( x ) = \frac{2 * exp ( - x )}{exp ( x ) + exp ( - x )} . \qquad B$$

for a regressive Value Unit.

The behavior of this family of curves represent the fact that the function is sensitive to changes in its argument in the vicinity of argument˜1, i.e. for Value Units around their reference values. For values VU>>VU_{ref} or VU<<VU_{ref} Criticality is not sensitive to changes in VU.

If an existing Value Unit changes its value from Old VU to a new value NewVU the Criticality NewCr of the Knowledge is recomputed as follows:

NewCr(Knowldge)=Cr(Knowledge)−IndCr(OldVU|Knowledge)+IndCr(NewVU|Knowledge) C

For a Knowledge the combined Criticality Cr(Knowledge) possible ways to combine the individual criticalities are:

Cr(Knowledge)=Σₐ IndCr(VU_{α}|Knowledge) D

For Requirements Req the combined Criticality Cr(Call) possible ways to combine the individual criticalities are:

$$Cr ( Req ) = {\sum }_{α} IndCr ( {VU}_{α} \vert Call ) \qquad E$$

If an existing value unit changes its value from OldVU to a new value NewVU the criticality NewCr of the requirement is recomputed as follows:

NewCr(Call)=Cr(Call)−IndCr(OldVU|Call)+IndCr(NewVU|Call) F

Effectiveness index EI (Resp, Call) of a capability Resp is computed as the difference between the criticality of the Call in the absence of the Response and the criticality of the Call when the Response is applied.

EI(Resp,Call)=Cr(Call)−Cr(Call,Resp) G

Criticality Cr(Call, Resp) is lower than Cr(Call) because value units in A3′ are changed by application of the Response Resp.

Efficiency index FI(Resp, Call) of a response Resp measures the effectiveness index EI (Resp, Call) of the response over cost spent on the response:

$$FI ( Resp , Call ) = \frac{EI ( Resp , Call )}{Cost ( Call )} \qquad H$$

Here is the summation is over all call Call from the OntologyUniverse of the organization, and over all the Responses Resp that can be applied to each Call.

Call Index CI(Call) is defined as the maximum efficiency indexes of all the Responses applied against this Call.

$$CI ( Call ) = {max}_{Resp ( Call )} FI ( Resp , Call ) \qquad I$$

### Case Study 4: Federated Search Engine Management.

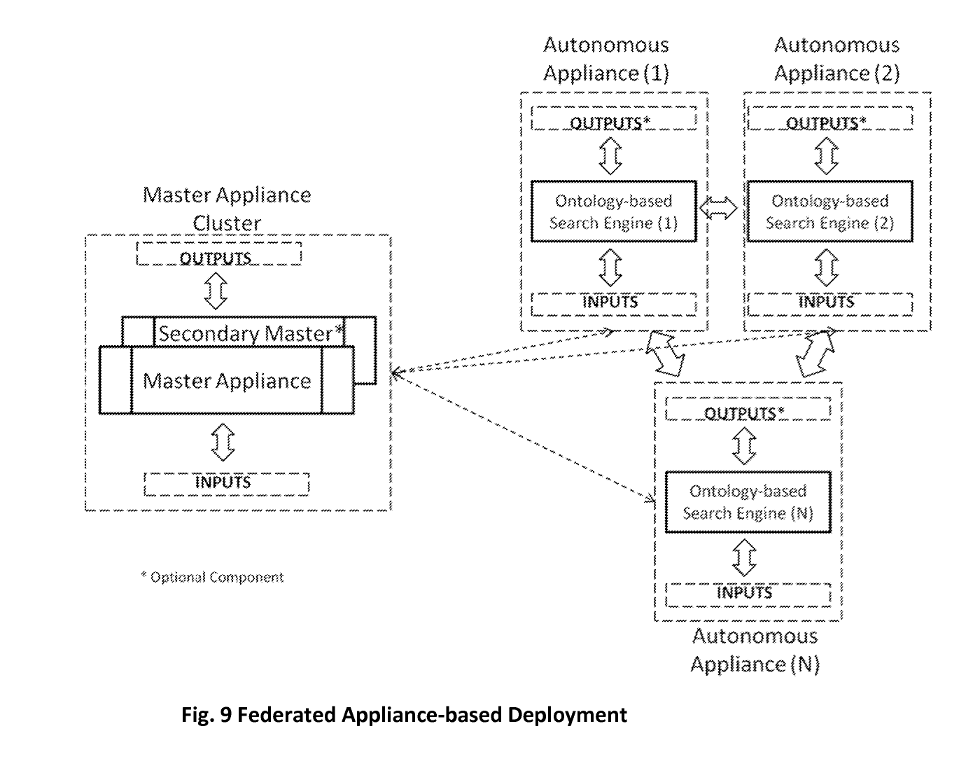

The objective of the Federated Search Engine Management is to leverage the present invention when multiple ontology-based search engine instances are implemented in a distributed manner for the purposes of (a) authority of content, (2) scalability, (3) integration of public and/or private knowledge, (4) information security or privacy, (5) language differences, (6) geographical disbursement, or any other business or scientific reason. In one embodiment, such an implementation can be deployed based on master-slave appliance-based architecture. FIG. 9 describes the concept.

Multiple instances of the present invention exist, represented as Autonomous Appliance (1), Autonomous Appliance (2), through Autonomous Appliance (N). Each Appliance is capable of sending outputs and receiving inputs to/from other appliances and the Master Appliance(s). The Master Appliance is responsible for the provisioning and managing of all Autonomous Appliances. Autonomous Appliances collect data from a set of Data Sources. As each Autonomous Appliance Ontology-based Search Engine (instance of the present invention) is in use, its ontology expands and over time begins to differ from the ontologies of the rest of the Autonomous Appliances.

In one embodiment, the Ontology of the Master Appliance is the Master Ontology and coordinates the aggregation of the Ontologies of the Autonomous Appliances. The Master Appliance sends relevant ontology and ontology index updates (filtered, modified or transparent) to all federated Autonomous Appliances keeping the entire collective of appliances (and ontologies) synchronized.

Users also can interact and perform various instructions and logical operations with all Autonomous Appliances through the Master Appliance. The federated deployment can include both public and private (behind an Organization's firewall) Autonomous Appliances.

Two specific examples further illustrate this case study:

### Example 1

A behind-the-firewall database stores data and knowledge which is of interest to authorized systems or processes outside of the firewall. The federated deployment allows data fusion and integration without the need for a traditional integration interface (e.g. Application Programming Interface) to be established. In this example, the user of the present invention can be another system. As an illustration, Internal Revenue Service creates a Messaging Service to service state health exchanges income verification (using SSNs) as part of the healthcare reform.

### Example 2

An Organization needs to create an adaptable knowledge-based management system capable of delivery knowledge (answers) based on ad-hoc questions or knowledge requests. In addition, the Organization needs to have an automated mechanism of integrating new knowledge into the knowledge system (i.e. expanding the underlying ontology of the present invention) when such knowledge appears in the Organization's email, file servers or other applications or storage repositories. As an illustration, an engineer is performing a repair operation and sends an ad-hoc inquiry via mobile device about the procedure at hand under the unusually harsh weather conditions. The present invention performs an ontology-based search and returns to the user only the relevant to the inquiry instructions.

### Example 3

Financial Services Organizations has the need to gather near real-time comprehensive information, including information about corporations, corporate executives, markets, businesses, and governments. Such information can include interest rates, inflation, analyst prediction, business market capitalization, market saturation rates, dollar exchange rates, etc. and is used to assess the overall economic and risk/gain profile for a financial asset. The present invention allows those Organizations to have current information and decision-making platforms that are superior to the current alternatives based on the underlying classification and contextual ontology-based data model. Moreover, the ontology can be tailored by each Organization to reflect their specific thresholds and alert triggers (e.g. via relative or absolute weight of each characteristic and change value).

### CONOPS (Concept of Operations)

In one embodiment, two main deployment concepts exist: Crowd Model: In this concept of operations, the present invention is deployed as a public website (such as Facebook, LinkedIn, Google, Bing, or Yahoo). Users can access the website and much like with Google, submit a free-form text describing their question. In English or any other supported by the present invention language. The three modules of the present invention:

Question Extractor. As users input questions, the ontology and logic of the present invention will become “smarter” and accuracy will increase. This in turn will create a positive use-spiral and more users will be attracted.

Call and Response Engine. As more question patterns and business/science knowledge are incorporated, the present invention will be able to more accurately integrate and retrieve questions, answers and domain knowledge into the ontology-based data model. This will result in the present invention becoming “smarter” and more accurate, which in turn will create a positive use-spiral and more users will be attracted.

Question Solver. As more answers are integrated (based on the accumulated knowledge of the Question Extractor and the Call and Response Engine), the ontology will expand and the logic of the present invention will become “smarter” and accuracy in constructing solutions will increase. Once again, this in turn will create a positive use-spiral and more users will be attracted to use the present invention.

Proprietary Model: This model is similar to the Crowd Model described above with the exception that the present invention is deployed within the perimeter of an Organization (similar to Google search within an Organization) or through a paid access. The three modules of the present invention operate the same way as described in the Crowd model.

### Data Model

The base ontology is described in terms of classes, object properties and data properties. The data model is business/science question and domain agnostic. The data schema contains elements that are independent of the details of any specific question and an answer that it is related to. Furthermore, the processing steps within the present invention will remain the same after the data model specifics are reflected.

The data model is captured in the base ontology. Additional classes and properties might be required to meet the needs of a specific business application.

### Deployment Architecture

The present invention can be deployed (1) as a stand-alone deployment, (2) on a cloud-based infrastructure based on a framework supporting data-intensive distributed applications such as, for example, HADOOP, or (3) as an appliance-based architecture.

### Technical Specifications

Technical architecture is comprised of several components:

Hardware:

Operating system: Using a 64-bit operating system helps to avoid constraining the amount of memory that can be used on worker nodes. For example, 64-bit Red Hat Enterprise Linux 6.1 or greater is often preferred, due to better ecosystem support, more comprehensive functionality for components such as RAID controllers.

Computation: Computational (or processing) capacity is determined by the aggregate number of Map/Reduce slots available across all nodes in a cluster. Map/Reduce slots are configured on a per-server basis. I/O performance issues can arise from sub-optimal disk-to-core ratios (too many slots and too few disks). Hyper Threading improves process scheduling, allowing you to configure more Map/Reduce slots.

Memory: Depending on the application, your system's memory requirements will vary. They differ between the management services and the worker services. For the worker services, sufficient memory is needed to manage the Task Tracker and Fileserver services in addition to the sum of all the memory assigned to each of the Map/Reduce slots. If you have a memory-bound Map/Reduce Job, you may need to increase the amount of memory on all the nodes running worker services. When increasing memory, you should always populate all the memory channels available to ensure optimum performance.

Storage: A Big Data platform that's designed to achieve performance and scalability by moving the compute activity to the data is preferable. Using this approach, jobs are distributed to nodes close to the associated data, and tasks are run against data on local disks. Data storage requirements for the worker nodes may be best met by direct attached storage (DAS) in a Just a Bunch of Disks (JBOD) configuration and not as DAS with RAID or Network Attached Storage (NAS).

Capacity: The number of disks and their corresponding storage capacity determines the total amount of the Fileserver storage capacity for your cluster. Large Form Factor (3.5″) disks cost less and store more, compared to Small Form Factor disks. A number of block copies should be available to provide redundancy. The more disks you have, the less likely it is that you will have multiple tasks accessing a given disk at the same time. More tasks will be able to run against node-local data, as well.

Network: Configuring only a single Top of Rack (TOR) switch per rack introduces a single point of failure for each rack. In a multi-rack system, such a failure will result in a flood of network traffic as Hadoop rebalances storage. In a single-rack system, this type of failure can bring down the whole cluster. Configuring two TOR switches per rack provides better redundancy, especially if link aggregation is configured between the switches. This way, if either switch fails, the servers will still have full network functionality. Not all switches have the ability to do link aggregation from individual servers to multiple switches. Incorporating dual power supplies for the switches can also help mitigate failures.

Software:

Hadoop—Hadoop is a project from the Apache Software Foundation written in Java to support data intensive distributed applications. Hadoop is an umbrella of sub-project around distributed computing.
Core: The Hadoop core consists of a set of components and interfaces that provide access to the distributed file system and general I/O (Serialization, Java RPC, Persistent data structures. The core components also provide “Rack Awareness”, an optimization which takes into account the geographic clustering of servers, minimizing network traffic between servers in different geographic clusters.
Map Reduce: Hadoop Map Reduce is a programming model and software framework for writing applications that rapidly process vast amounts of data in parallel on large clusters of computer nodes.
HDFS: Hadoop Distributed File System (HDFS) is the primary storage system used by Hadoop applications.
HBase: HBase is a distributed, column-oriented database. HBase uses HDFS for its underlying storage. It supports batch style computations using MapReduce and point queries (random reads). HBase is used in Hadoop when random, real-time read/write access is needed.
Pig: Pig is a platform for analyzing large data sets. It consists of a high-level language for expressing data analysis programs, coupled with infrastructure for evaluating these programs.
ZooKeeper: ZooKeeper is a high-performance coordination service for distributed applications. ZooKeeper centralizes the services for maintaining the configuration information, naming, as well as providing distributed synchronization, and group services.
Hive: Hive is a data warehouse infrastructure built on top of Hadoop. Hive provides tools to enable easy data summarization, ad-hoc querying and analysis of large datasets stored in Hadoop files. It provides a mechanism to put structure on this data using a simple query language called Hive QL.
Chukwa: Chukwa is a data collection system for monitoring large distributed systems.
Semantic Web—Semantic Web provides a back structure to the information by describing and linking data to establish context or semantics that adhere to defined grammar and language constructs. The structures are semantic annotations that conform to a specification of the intended meaning.

What is claimed is:

1. A computer-based method to identify and solve problems that exist in a real-world system, the method comprising the steps of:
i. Call and response messaging system
ii. receiving as input a description of the real-world system in one or more of structured data inputs, natural language according to a predetermined syntax;
iii. extract system problem and formulate a search call;
iv. each said search call identifying a problem pattern that exists in the real-world system;
v. access and search data;
vi. formulate response;
vii. generate signaling output(s) of formulated response;
viii. refine the method to enhanced state for future iterations
ix. one or more computers with server functions for holding and presenting the described information.

2. The method of claim 1 wherein the said data can be an ontology-based knowledge;

3. The method of claim 1 further comprising of processing steps for being enabled by a plurality of computer appliances and peripherals, controlled by a control center, in a networked control system;

4. The method of claim 1 further comprising of steps for control center registering computer appliances and peripherals or the computer appliance registers peripherals for the purposes of one or more of management, control, remote administration, re-registering, re-provisioning, updating software, ensuring updates/security fixes/configuration files are applied, monitors operation and performance;

5. The method of claim 1 further described of the processing step to allow operator to find or receive said response to the said call problem(s);

6. The method of claim 1 wherein the said real-world system is one of identity management, engineering environments, technical domain-specific environments, business environments, social environments, behavioral environments, economic environments, political environments, and individual components;

7. The method of claim 1 further described by an architecture comprised of the following: question extractor, call and response engine, question solver, data bank(s), tools and administrative;

8. The method of claim 1 wherein the said search is comprised of steps for Federated Search Engine Management in a distributed manner for the purposes of one of authority of content, scalability, integration of public and/or private knowledge, information security or privacy, language differences, geographical disbursement, or any other business or scientific reason.

9. The method of claim 1 further comprising the step of outputting the said formulated solution to an operator;

10. The computer-based method of claim 1 wherein the real-world system is one of identity, product, knowledge, data, information;

11. A computer-based method to identify and solve problems that exist in a real-world system, the method comprising the steps of:
i. Call and response messaging system;
ii. Comprised of steps for clearinghouse processing;
iii. receiving as input a description of the real-world system in one or more of structured data inputs, natural language according to a predetermined syntax;
iv. extract system problem and formulate a search call;
v. each said search call identifying a problem pattern that exists in the real-world system;
vi. access and search data;
vii. formulate response;
viii. generate signaling output(s) of formulated response;
ix. refine the method to enhanced state for future iterations
x. one or more computers with server functions for holding and presenting the described information.

12. The method of claim 11 wherein the said data can be an ontology-based knowledge;

13. The method of claim 11 further comprising of processing steps for being enabled by a plurality of computer appliances and peripherals, controlled by a control center, in a networked control system;

14. The method of claim 11 further comprising of steps for control center registering computer appliances and peripherals or the computer appliance registers peripherals for the purposes of one or more of management, control, remote administration, re-registering, re-provisioning, updating software, ensuring updates/security fixes/configuration files are applied, monitors operation and performance;

15. The method of claim 11 further described of the processing step to allow operator to find or receive said response to the said call problem(s);

16. The method of claim 11 wherein the said real-world system is one of identity management, engineering environments, technical domain-specific environments, business environments, social environments, behavioral environments, economic environments, political environments, and individual components;

17. The method of claim 11 further described by an architecture comprised of the following: question extractor, call and response engine, question solver, data bank(s), tools and administrative;

18. The method of claim 11 wherein the said search is comprised of steps for Federated Search Engine Management in a distributed manner for the purposes of one of authority of content, scalability, integration of public and/or private knowledge, information security or privacy, language differences, geographical disbursement, or any other business or scientific reason.

19. The method of claim 11 further comprising the step of outputting the said formulated solution to an operator;

20. The computer-based method of claim 11 wherein the real-world system is one of identity, product, knowledge, data, information;
